(19) United States
(12) Patent Application Publication
(10) Pub. No.: US 2015/0098695 A1
(43) Pub. Date: Apr. 9, 2015

(54) Program Managing System, Program Recorder and Program Managing Method

(71) Applicants: Kabushiki Kaisha Toshiba, Tokyo (JP); Toshiba Lifestyle Products & Services Corporation, Tokyo (JP)

(72) Inventor: Masaya Yamasaki, Ome-shi (JP)

(21) Appl. No.: 14/465,554

(22) Filed: Aug. 21, 2014

Related U.S. Application Data
(60) Provisional application No. 61/887,875, filed on Oct. 7, 2013.

(51) Int. Cl. H04N 5/781; H04N 21/41; G11B 27/10; H04N 21/433; H04N 5/445; G11B 27/34

(52) U.S. Cl. CPC H04N 5/781; H04N 5/44543; G11B 27/34; G11B 27/102; H04N 21/4332; H04N 21/4334; H04N 21/4135; H04N 2005/44547
USPC 386/297

(57) ABSTRACT

In accordance with an embodiment, there is provided a program managing system for recording programs broadcasted through a plurality of channels over a predetermined term, and providing a designated program in response to a user's request through a network. In this system, a past program table showing program content in display regions of the respective programs is generated, based on program information on the recorded programs corresponding to the plurality of channels. Further, the display region of an already replayed program in the past program table is overlaid with a translucent color indicating a bar graph corresponding to a replay-finish ratio, based on a replay history included in the program information.

### CROSS-REFERENCE TO RELATED APPLICATIONS

This application claims the benefit of U.S. Provisional Application No. 61/887,875, filed Oct. 7, 2013, the entire contents of which are incorporated herein by reference.

### FIELD

Embodiments described herein relate generally to a program managing system, a program recorder and a program managing method for recording and managing broadcast programs.

### BACKGROUND

Among program recorders for recording TV programs, a recorder capable of recording, at a time, all programs broadcasted through a plurality of channels over a plurality of dates has recently become available. A user who operates the program recorder needs to select a program they want to view from the recorded programs. To this end, the program recorder performs program table control processing, in which a past program table displaying a list of programs recorded at a time is prepared, and the display form of the list is controlled to an easily viewable form.

On the other hand, so-called cloud services for providing broadcast programs requested by users through, for example, the Internet have been realized due to enhancement of transmission rate in the network. Also in this case, a past program table displaying a list of programs recorded at a time is necessary to permit the users to easily select a program they want to view.

In the “display of a past program table in a program recorder” so far, a mark indicating finishing of replay is displayed in a replay-finished program field. In this case, however, even after only the beginning part of a program is replayed and then stopped in a short time, this program is treated as “a replay-finished program.” Namely, from the replay-finished mark, it cannot be detected whether the entire program was replayed. When it is not detected “whether the entire program is already replayed,” missing viewing (it is erroneously judged that the entire program is already replayed, and the program is deleted even though it is not substantially viewed) or redundant replay (after a program is replayed, it is detected that the program was once replayed) may well occur. Missing viewing is fatal, in particular, if the program recorder is designed such that recorded programs are automatically deleted in the order beginning with the oldest one after a predetermined period elapses.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 schematically shows the structure of a program managing system according to embodiments;

FIG. 2 is a block diagram showing a structure example of a program recorder for use in the system of FIG. 1;

FIG. 3 shows an example of a multiple replay scheme employed in the program recorder shown in FIG. 2;

FIG. 4 is a table showing an example of a data structure in a program database employed in the program recorder shown in FIG. 2;

FIG. 5 is a table showing a data structure example of metadata processed by the program recorder shown in FIG. 2;

FIG. 6 is a front view of an example of a remote controller used for the program recorder shown in FIG. 2;

FIG. 7 shows an example of a program table generated by the program recorder shown in FIG. 2;

FIG. 8 is a flowchart of generating a past program table according to a first embodiment;

FIG. 9 shows a first display example of the past program table according to the first embodiment;

FIG. 10 shows a second display example of the past program table according to the first embodiment;

FIG. 11 is a flowchart of generating a past program table according to a second embodiment;

FIG. 12 shows a display example of the past program table according to the second embodiment;

FIG. 13 is a flowchart of generating a past program table according to a third embodiment;

FIG. 14 shows a display example of the past program table according to the third embodiment;

FIG. 15 is a flowchart of generating a future program table according to a fourth embodiment; and

FIG. 16 shows a display example of the future program table according to the fourth embodiment.

### DETAILED DESCRIPTION

Various embodiments will be described hereinafter with reference to the accompanying drawings.

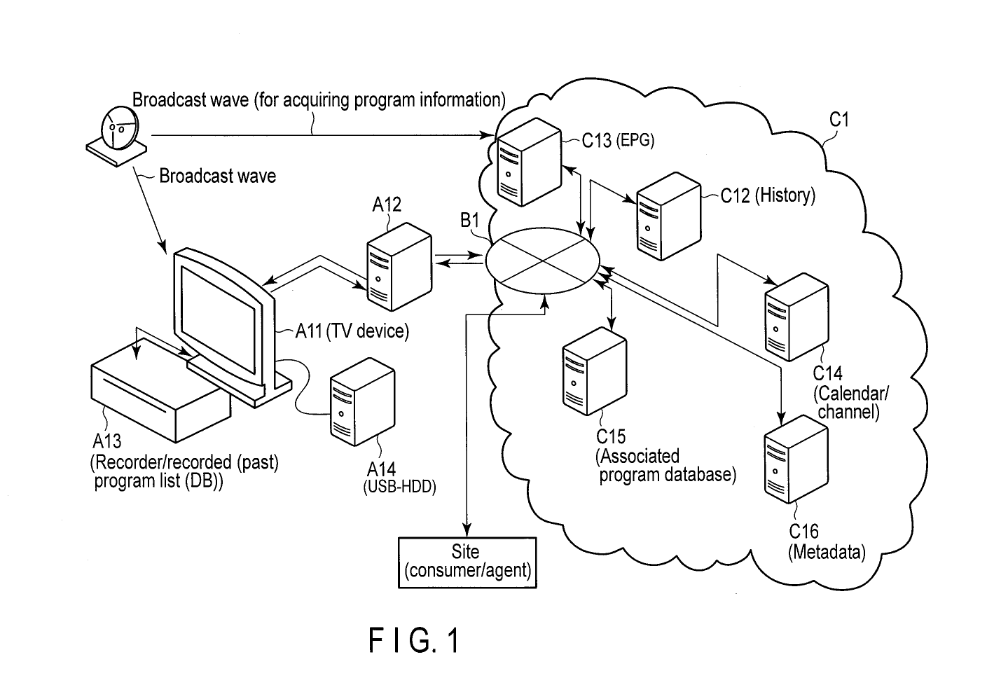

FIG. 1 schematically shows the structure of a program managing system according to embodiments. As shown in FIG. 1, this system comprises an electronic device A11 as a client terminal owned by a user, a data controller A12 for connecting the electronic device A11 to an external network (e.g., the Internet) B1, and one or more servers (external servicing mechanism) C1 positioned on the Internet B1. The external servicing mechanism C1 will hereinafter also referred to as, for example, a cloud service (program community). The data controller A12 can be built in the electronic device A11.

The electronic device A11 is, for example, a digital television broadcast receiver (hereinafter, a TV device) capable of receiving and replaying programs. FIG. 1 shows a case where the TV device A11 is connected to a recorder A13 or to a USB hard disk device A14 for recording predetermined programs under the control of the TV device A11.

If the TV device A11 has a recording function, it can generate a recorded-program list of programs already recorded and stored in the TV device A11, the recorder A13 and the USB hard disk device A14. In contrast, if the TV device A11 has no recording function, it has a home server function, i.e., it functions as a database capable of generating a recorded-program list of programs already recorded and stored in the recorder A13 and the USB hard disk device A14.

Any type of device may be used as the TV device A11, if it has a user interface function, a wired or wireless communication function (capable of performing, for example, short distance wireless communication, such as Bluetooth (trademark), and external communication through the Internet B1), a function of receiving broadcasts, a function of processing received broadcasts or programs, a program output function of outputting programs or a memory (recording) function, etc. For instance, a personal computer (PC) having a function of receiving broadcasts, a video display device (monitor device) connected to a video recording device (recorder) having a broadcast receiving device, or a mobile terminal device having a broadcast receiving function can be used as the device 11A. The broadcasts include, for example, those provided by a broadcast enterprise (broadcast station) as radiation propagating spatially, and those distributed by a distribution enterprise through a network, such as a cable or an IP (Internet Protocol) network. Further, the broadcasts include video and audio data and/or music, and provide programs of certain periods (broadcast period) sequentially or for a predetermined period of time. The programs may also be referred to as content or streams. The video data includes a moving image, a still image, or text (information represented by characters or symbols indicated by a series of codes), and any arbitrary combinations thereof.

The external servicing mechanism C1 includes, for example, a history server (taste information database) C12, an EPG server (database) C13, a calendar/channel data server (database) C14, an associated program database (server) C15 and a data source server (metadata server) C16. The history server C12, the EPG server C13 and the associated program database C15 may be managed by the maker of the TV device A11 or its committed company, or may be prepared and managed by a company independent of the maker. On the other hand, the data source server C16 is generally prepared and managed by, for example, a metadata creating organization (metadata creating company).

The history server C12 stores, for example, information indicating user's tastes, such as the programs viewed or recorded by the user, i.e., history data (log data). Further, the history server C12 acquires information associated with, for example, an access history concerning the sites accessed by the TV device A11, settlement of articles or concert tickets purchased at the accessed sites, or settlement of lodgment arrangement. Transfer of data between the TV device A11 and the history server C12, i.e., supply (transmission) of information from the TV device A11 to the history server C12, and acquisition (reception) of information by the TV device A11 from the history server C12, is performed under the control of the data controller A12.

The data controller A12 controls transfer of data between the TV device A11 and the external servicing mechanism C1, i.e., each of the history server C12, the EPG server C13, the calendar/channel data server C14, the associated program database C15 and the data source server C16. Also, the data controller A12 controls recommendation processing for accepting a recommendation from the user and processing it as taste information (the controller functions as a recommendation processing engine (RE)).

The data controller A12 further controls connection and transfer of data between the TV device A11 and an arbitrary site (webpage) on the Internet B1. The data controller A12 may be interposed between the TV device A11 and the network (the Internet B1), or within the external servicing mechanism C1.

The EPG server C13 acquires information associated with the programs received by the TV device A11, independently of the direct reception of the programs by the TV device A11, and stores the information as a database (DB).

The calendar/channel data server (database) C14 stores the broadcasting dates of (TV) programs beforehand programmed by the user, the channel names the user can access (to view/record the programs), the channel names provided by a distribution company, data indicating the schedule of a program to be broadcasted by another station (the schedule overlapping the broadcast time of the program programmed by the user), information indicating rebroadcasting (including the program programmed by the user), etc.

When the user supplies the TV device A11 with a predetermined operation input (instruction) while a program is being viewed or a recorded program is being replayed, using a remote controller (an operation input unit or a mobile terminal device), the associated program database C15 extracts a program and data associated with the user's viewed program or the user's programmed program stored in the history server C12, from the various types of data supplied from the data source server 5 to the database C15, as will be described later.

The data source server C16 is prepared and managed by a metadata creating organization (company) that processes various types of information associated with the above-mentioned processing, i.e., metadata. The data source server C16 stores various types of extractable data which includes a keyword received from the user (TV device) A11 or the history server C12, user's taste information stored in the history server C12, such as a user viewed program, a user's recording programmed program, “a keyword” included in the program, and user's registered information.

The TV device A11 stores a cloud application (HTML/JS/CSS) as the firmware of a CPU (processor) incorporated in the device A11, in order to access the Internet B1 via the data controller A12. The cloud application may be acquired as an application when the CPU is operable, or be prestored in, for example, a recording medium.

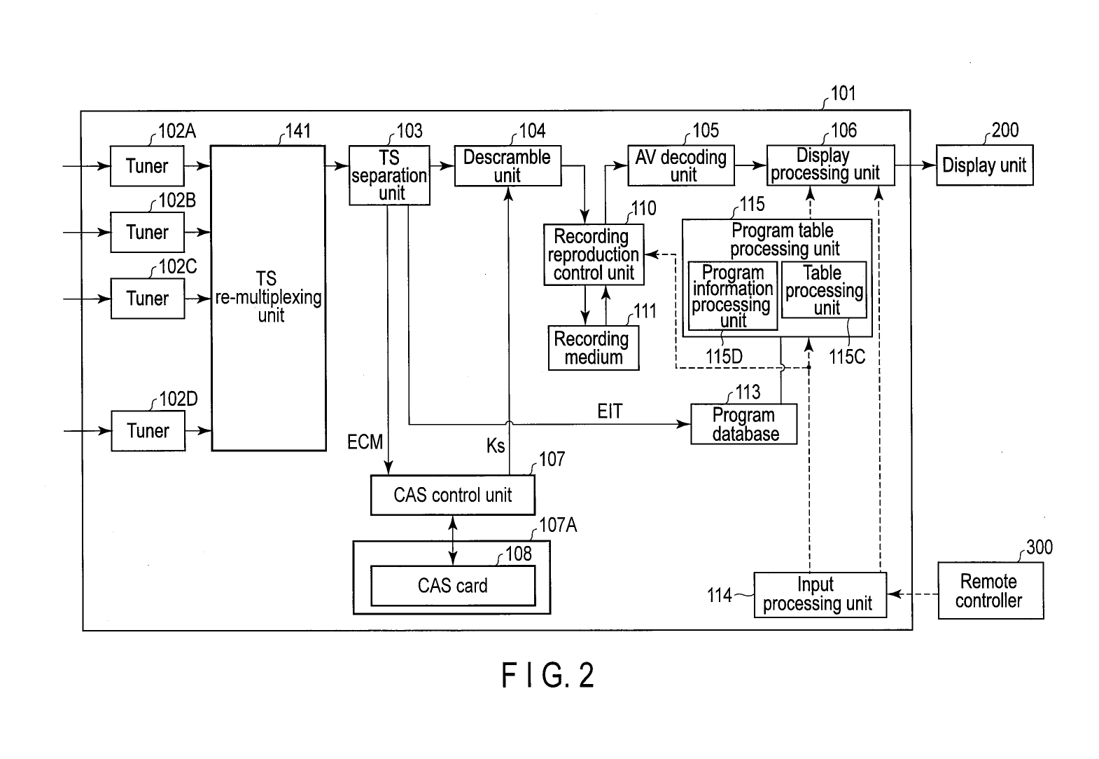

FIG. 2 is a block diagram showing a structure example of a program recorder (digital recorder) 101 for recording programs for the TV device A11. In the embodiments, the program recorder 101 comprises, for example, four tuner modules as receiving sections for receiving scrambled digital broadcast signals (two of the tuner modules are tuners 102A and 102B for terrestrial digital broadcasting, and the other two are tuners 102C and 102D for BS/CS digital broadcasting).

The broadcasting signals received by the first tuner 102A, the second tuner 102B, the third tuner 102C and the fourth tuner 102D are input to a TS re-multiplexing unit 141, where the TSs (transport streams) of a plurality of channels (CH) are multiplexed into one TS.

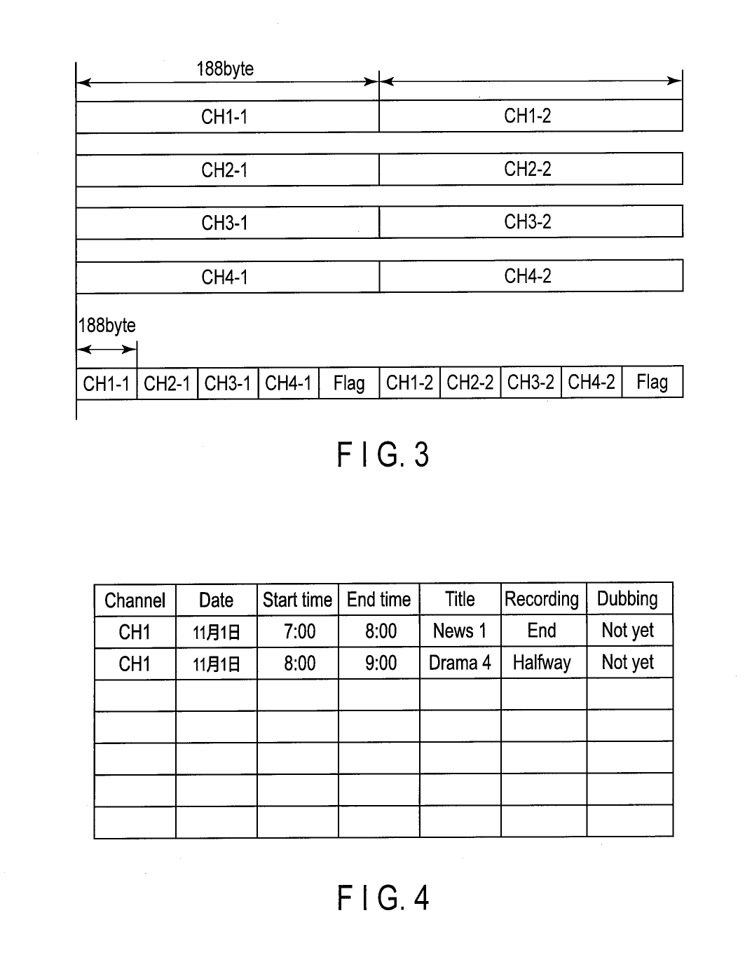

FIG. 3 shows an example of a re-multiplexing scheme employed in the TS re-multiplexing unit 141. In this scheme, in the case of 4CH inputs, arrangement of packets is re-multiplexed at a speed five times that of input packets as shown in the figure. Further, in this case, “Flag” packets are added in the packet arrangement to add timestamp information for each packet. However, the TS re-multiplexing scheme is not limited to this, but various schemes can be employed. The signal re-multiplexed by the TS re-multiplexing unit 141 is sent to a TS separation unit 103.

The TS separation unit 103 separates, from the broadcasting signal, an entitlement control message (ECM) as encryption information, and an event information table (EIT) writing event information, such as a program name, performers and a start time.

The ECM separated by the TS separation unit 103 is transferred to a CAS control unit 107. The CAS control unit 107 decodes the encryption of the ECM using a work key (Kw), and compares extracted attribute information concerning a program with contract information stored in a CAS card 108, thereby determining whether viewing of the program is allowable. Each work key (Kw) is set for a corresponding broadcasting enterprise stored in a CAS module (this is a CAS card as an IC card and will also be referred to as the “CAS card”) 108.

The CAS control unit 107 decodes the scramble key (Ks) after the viewing determination is performed, and outputs the decoding result to a descramble unit 104. Different encryption keys Ks and Kw are set for different broadcasting enterprises, but are each shared between all receivers.

The EIT separated by the TS separation unit 103 is input to a program database 113, where the EIT is used to compile a database for generating a program table.

FIG. 4 is a schematic view of the data structure employed in the program database 113. As shown in FIG. 4, information items, such as a channel, a date, a program starting time, a program ending time, a title, a recording state (finish of recording, mid-flow of recording) and information indicating whether dubbing was performed, are tabled for each program.

The descramble unit 104 sets the scramble key Ks input by the CAS control unit 107 and sends a descrambled TS to a recording reproduction control unit 110.

The recording reproduction control unit 110 can return the re-multiplexed TS to TSs corresponding to respective channels, and record the TSs in a recording medium 111, such as a hard disk drive (HDD). The recording reproduction control unit 110 can also execute control for reproducing a TS as a broadcasting signal recorded in the recording medium 111 to thereby output a resultant signal to an AV decoding unit 105. Namely, the recording reproduction control unit 110 cabinet function as a recording control unit and a reproduction control unit.

The recording reproduction control unit 110 stores to-be-recorded programs as TS files in the recording medium 111 for the respective channels. The to-be-recorded programs are determined by designating conditions, such as a channel, a time zone and a day of the week. It is assumed that if the amount of record in the recording medium 111 reaches its limit, the recording reproduction control unit 110 continues recording while sequentially deleting the data beginning with the oldest record time. In the description below, the program data in each TS file in the recording medium 111 will be referred to as “a past processing.”

When recording TSs corresponding to respective channels in the recording medium 111, the recording reproduction control unit 110 generates metadata obtained by associating a recording position (physical address) in the physical region of the recording medium 111 with program information is created for each channel, and records the metadata in the recording medium 111. Also in a case where data is recorded in a more compressed form (e.g., H. 264) than the TS file form in order to reduce the data record amount in the recording medium 111, the following explanation is applicable:

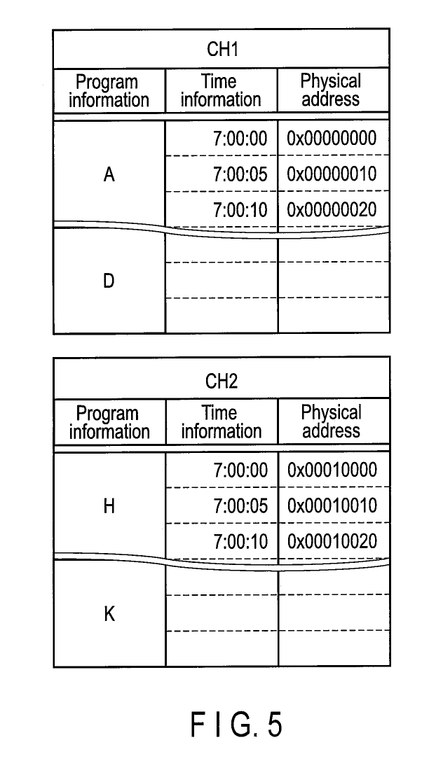

Namely, metadata obtained by associating, with each other, a recording position (physical address) in the physical region of the recording medium 111, time information (indicating a relative time obtained using the record start position of a program as a reference time), and program information is created for each channel, and records the metadata in the recording medium 111. In the example shown in FIG. 5, recording positions (physical addresses) are recorded per 5 seconds. The program information can be acquired from the EIT.

The recording medium 111 is, for example, an HDD, a disk drive or an SD (trademark) card reader/writer, and records TSs as broadcasting signals output from the recording reproduction control unit 110. The recording medium 111 does not always have to be built in the digital recorder 101, but may be a recording medium, such as an HDD, connected via a USB or LAN.

The AV decoding unit 105 decodes, into AV information (video and audio data), broadcasting program signals (TS streams corresponding to respective channels) corresponding to respective channels and received by the tuners 102A, 102B, 102C and 102D, or broadcasting signals (TS streams corresponding to respective channels) reproduced by the recording reproduction control unit 110.

The decoded output (AV output) of the AV information is sent to a display unit 200 as an external monitor via a display processing unit 106. Further, the display processing unit 106 has a graphical user interface (GUI) function for providing a user with information using an On Screen Display (OSD). By the GUI function, a program table described later, for example, is displayed on the display unit 200.

A program table processing unit 115 receives, from the program database 113, the EIT of the programs recorded in the recording medium 111, and the EIT of the programs to be broadcasted in the future, thereby generating data for generating a program table and displaying the program table on the screen of the display unit 200.

More specifically, the program table processing unit 115 comprises a time/date designating jump table processing unit (hereinafter referred to simply as “a table processing unit”) 115C, and a program information processing unit 115D. The table processing unit 115C can process a time/date designating jump table having a plurality of cells for discriminating times and dates based on time/date information indicating past, present and future dates and times. The program information processing unit 115D can manage display of the time/date designating jump table, and can output, based on associated data, a program table as a table for display when an arbitrary number of cells are selected by selection means, the program table showing program information associated with (a) past, (b) present, (c) future, (d) past and present, (e) present and future, or (f) past, present and future.

The input processing unit 114 accepts various types of inputs from a user. For instance, the input processing unit 114 accepts designation of display of the time/date designating jump table, also accepts inputs to select and designate cells on the time/date designating jump table, and accepts inputs to set automatic recording and designate a to-be-reproduced program, etc.

The input processing unit 114 may accept a user input from a device corresponding to an operation panel (not shown) attached to the digital recorder 101, or accept a user input from a remote controller 300 separate from the digital recorder 101.

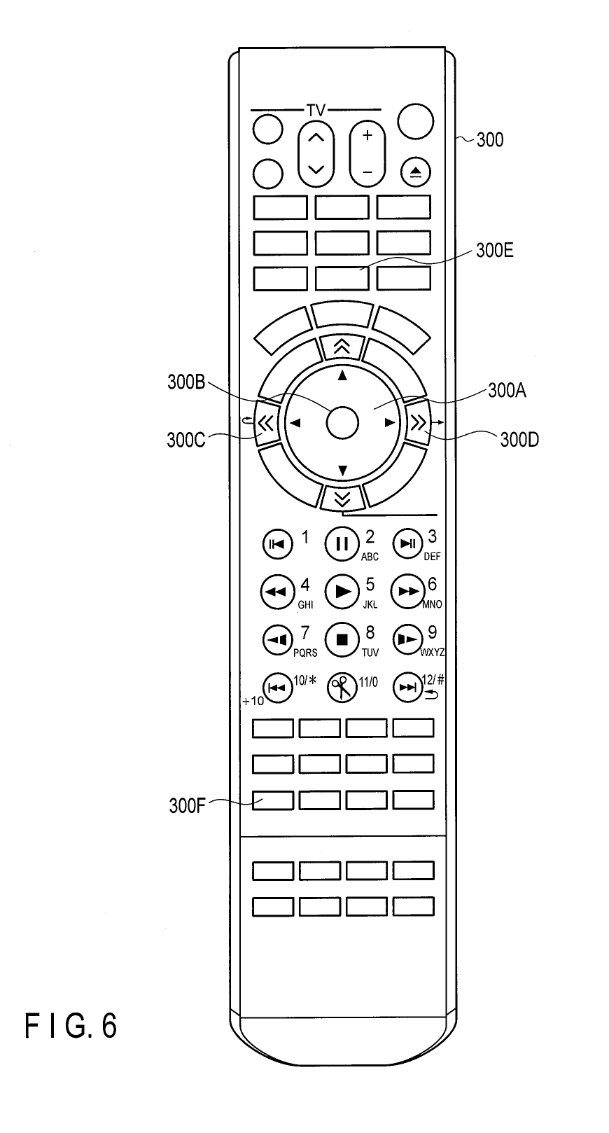

FIG. 6 shows the appearance of the remote controller 300. The remote controller 300 mainly comprises a cursor key 300A, a determination key 300B, a page return key 300C, a page advance key 300D and a time shift key 300E.

The cursor key 300A is provided to shift a designated region (focus) on the program table, the time/date designation jump table, or the like, described later. The determination key 300B is provided to determine the designated region. The page return key 300C and the page advance key 300D are provided to change the display range, such as the program table or the time/date designating jump table.

The time shift key 300E is used to display a program table that displays programs simultaneously recorded. When the time shift key 300E is pressed, the program information processing unit 115D and the program table processing unit 115 display the program table on the screen of the display unit 200. At this time, the apparatus enters a so-called time shift mode in which the program designated through the display screen can be replayed.

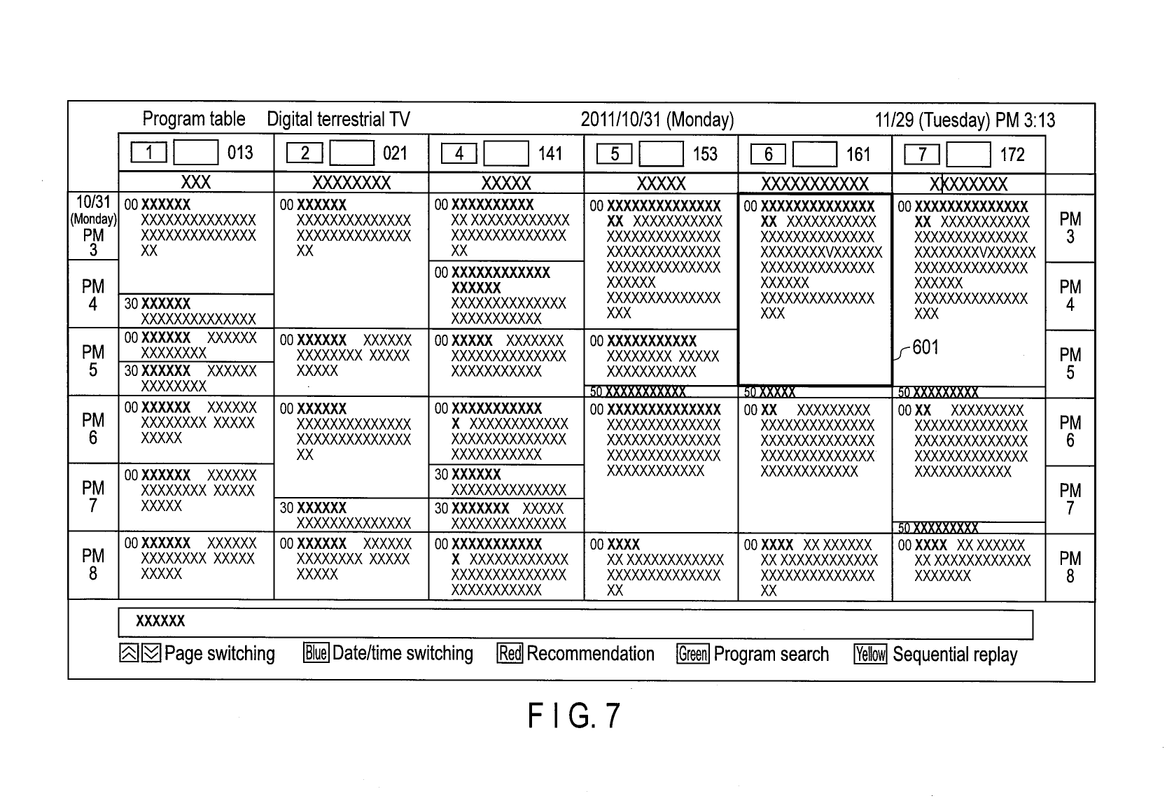

FIG. 7 shows an example of the program table. This program table shows past programs, and has a plurality of cells, the vertical (column) line denoting time, the horizontal (row) line denoting channels. This past program table is a user interface that permits a user to replay programs. This figure shows a case where programs corresponding to six channels are recorded. In this case, the number of tuners as shown in FIG. 2 is six.

A description will now be given of viewing history display processing associated with the past program table according to the embodiments, performed by the program recorder 101 constructed as the above.

### First Embodiment

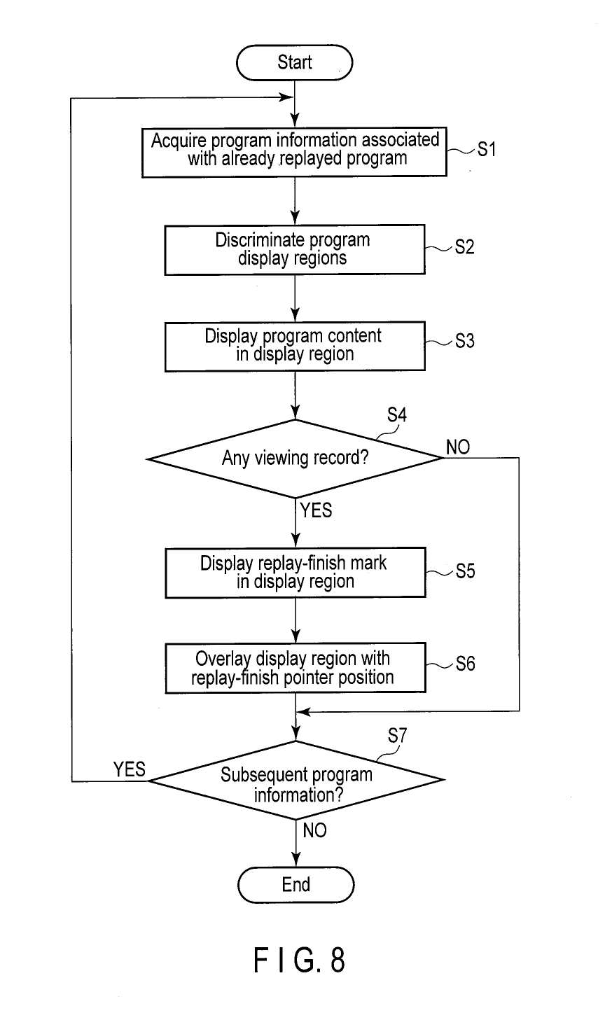

FIG. 8 is a flowchart of the processing procedure of the program table processing unit 115 for displaying a viewing history, according to a first embodiment.

In FIG. 8, firstly, program information items corresponding to already recorded programs are fetched in the order of recorded time and in the order of channel, each program information at least including a channel, a recording period, a record of viewing, a replay-finish ratio (the ratio between a required total program replay time and the time for which replay was already performed) (step S1). Subsequently, a display region is discriminated for an input program, based on a channel and time (step S2), and then program content, such as a title, is displayed on the display region (step S3). After that, it is determined for each program whether there is a viewing record (step S4). If there is a viewing record, a replay finish mark indicating that there was a viewing record is displayed in the discriminated display region (step S5). Thereafter, the replay-finish ratio is read, and the display region is overlaid with a translucent color indicating a replay-finish pointer position corresponding to the replay-finish ratio (step S6). At this time, it is determined whether subsequent program information exists (step S7). If subsequent program information exists, the processing returns to step S1, and the subsequent program information is acquired. If there is no viewing record in step S4, the processing proceeds to step S7. The above processing is iterated for all recorded programs.

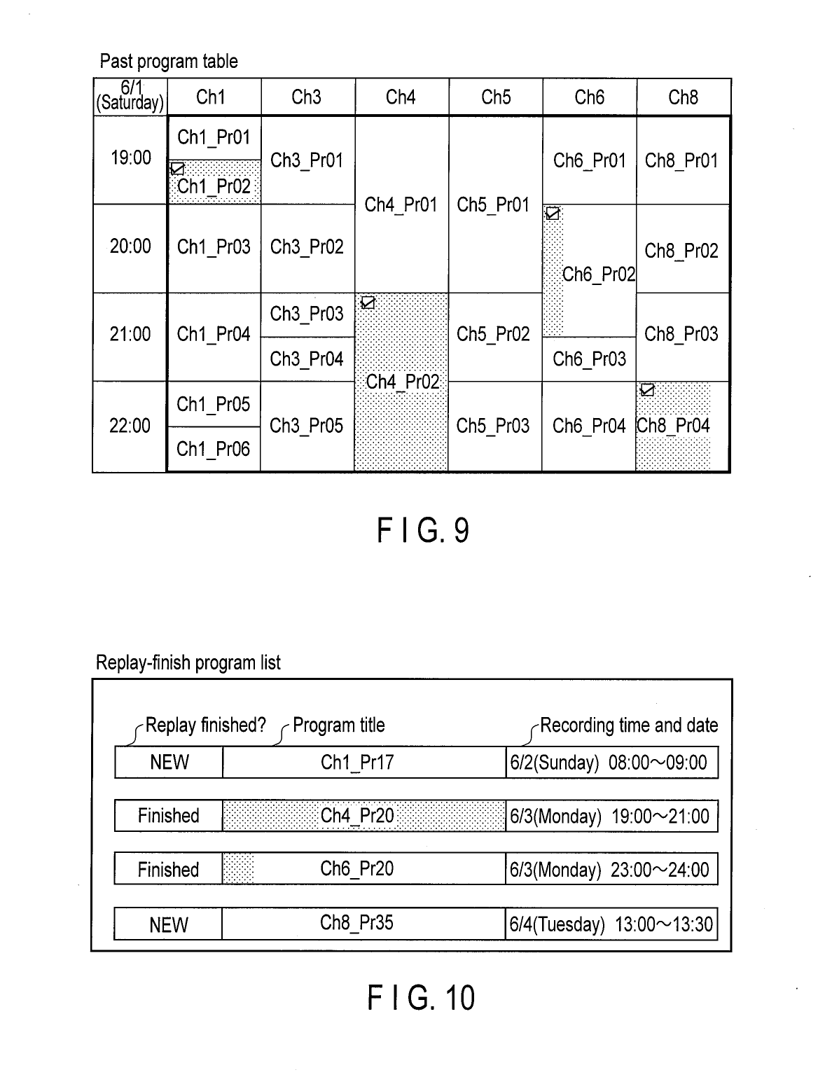

FIG. 9 shows a first display example of the program table including a viewing history. This display example shows programs corresponding to six channels (Ch1, Ch3, Ch4, Ch5, Ch6 and Ch8) and recorded on June 1 (Saturday) from 19:00 to 22:00. In this example, programs Ch1_Pr02, Ch4_Pr02, Ch6_Pr02 and Ch8_Pr04 are each provided with the replay-finish mark and also each overlaid with a translucent color indicating the replay-finish pointer position. The first embodiment is characterized in that “the replay-finish pointer position (i.e., the relay-finish ratio of each program) is displayed by overlaying each replay-finish program with a translucent color.” This feature of the first embodiment provides the following advantage that cannot be obtained by the prior art.

As a specific method of realizing the first display example, information indicating each replay-finish program is overlaid with a translucent color to indicate the replay-finish pointer position (corresponding to the replay-finish ratio of the entire program). In the example of FIG. 9, the information indicating each program, i.e., each program frame (display region), is overlaid with a horizontal bar indicating by what percentage each program was finished. As a result, in the example of FIG. 9, the replay-finish ratio of each replay-finished program can be grasped at a glance, as follows: Ch1_Pr02: 100%, Ch4_Pr02: 100%, Ch6_Pr02: approx. 20%, and Ch8_Pr04: approx. 80%.

The first display example is characterized in that when there is an area corresponding to “the existing display region (program frame),” it is sufficient if the region is overlaid with a translucent color, namely in that no additional display area is necessary. It is a matter of course that if there is an extra region, the extra region may be used as an additional display region.

In the above processing result, since Ch1_Pr02 and Ch4_Pr02 are already replayed by 100%, and therefore do not have to be replayed unless the user wishes to replay them again. In contrast, regarding Ch6_Pr02 that was replayed by only approx. 20%, the user may well intend to replay the remaining 80% before this program is automatically erased. Similarly, regarding Ch8_Pr04 that was replayed by approx. 80%, the user may well think that the main part of the program was replayed and the trailer and commercial parts were skipped over, and therefore that this program does not have to be replayed (however, to make sure, it may be replayed again). Thus, the above overlay processing can provide the user with appropriate information for making a decision, which means that the conventional problems, such as missing viewing and multiple replay, can be overcome.

Although the above embodiment employs a display form in which programs are arranged in time-series manner in association with channels, such a second display form as shown in FIG. 10 may be employed. In the format of FIG. 10, each program whose recording was finished is provided with information indicating whether it is already replayed, indicating its title, and indicating the date and time of recording. Further, each replay-finished program is overlaid with a translucent color indicating a replay-finish pointer position (the replay-finish ratio of each program). This display form is also applicable to the case of recording selected programs, as well as the case of recording all programs.

More specifically, the second display example of FIG. 10 shows four programs recorded on June 2 (Sunday) through June 4 (Tuesday). In this example, a non-replay mark “NEW” is attached to Ch1_Pr17 and Ch8_Pr35, the replay-finish mark (Finished) is attached to Ch4_Pr20 and Ch6_Pr20, and additionally, each replay-finished program is overlaid with a translucent color indicating a replay-finish pointer position. The first embodiment is characterized in that “each replay-finished program is overlaid with a translucent color indicating a replay-finish pointer position (the replay-finish ratio of each program).”

As a specific method of realizing the second display example, information indicating each replay-finish program is overlaid with a translucent color to indicate the replay-finish pointer position. In the example of FIG. 10, the information indicating each program, i.e., each program name, is overlaid with a horizontal bar indicating by what percentage each program was finished. As a result, in the example of FIG. 10, the replay-finish ratio of each replay-finished program can be grasped at a glance, as follows: Ch1_Pr20: 100% and Ch6_Pr20: approx. 20%.

Also the second display example, when there is an area corresponding to “the existing display region (program name),” it is sufficient if the region is overlaid with a translucent color, namely in that no additional display area is necessary. It is a matter of course that if there is an extra region, the extra region may be used as an additional display region.

Thus, the above overlay processing can provide the user with appropriate information for making a decision, such that Ch4_Pr20 that is already replayed by 100% does not have to be replayed, while Ch6_Pr20 was replayed only by approx. 20%, and therefore the remaining non replay-finish part is to be replayed before it is erased. As a result, problems, such as missing viewing and multiple replay, can be overcome.

### Second Embodiment

In the first embodiment described above, as an improved point for simultaneous recording of all channels, the replay-finish ratio of each replay-finish program can be grasped at a glance by overlaying each replay-finish program with a translucent color that indicates the replay-finish pointer position, thereby overcoming the conventional problems, such as missing viewing and multiple replay. In a second embodiment, measures for further positively reminding replay will be described.

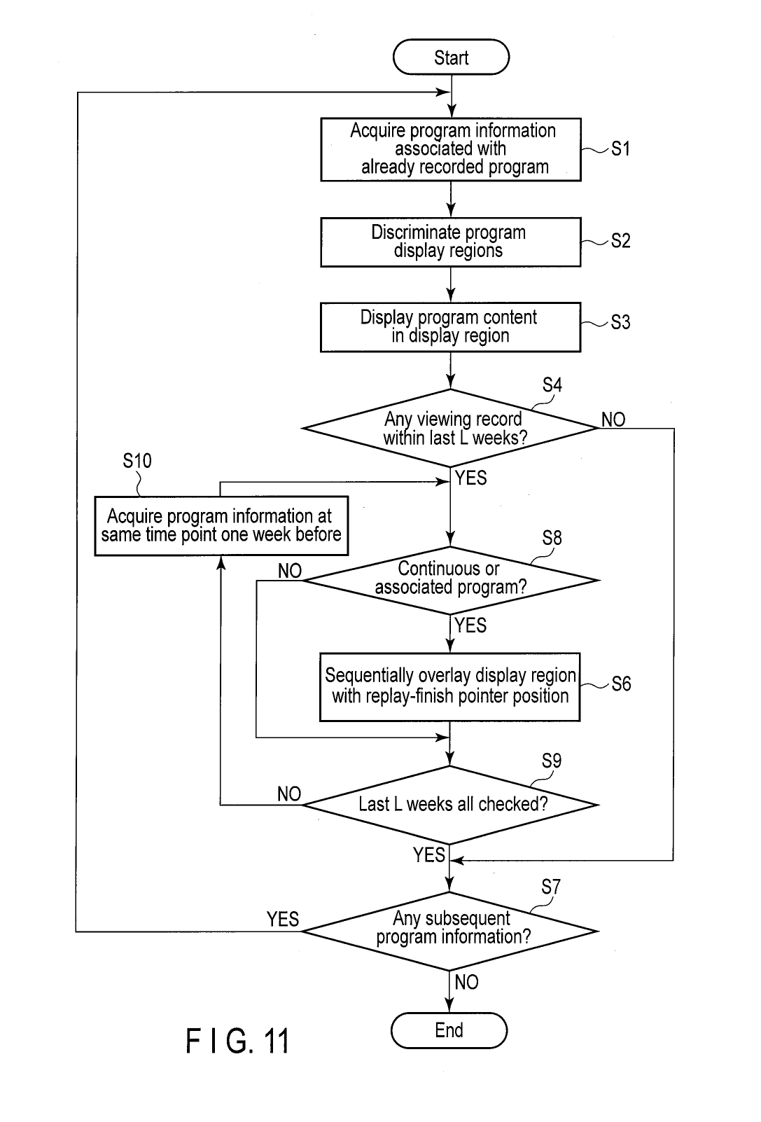

FIG. 11 is a flowchart of processing, according to the second embodiment, for causing the program display processing unit 115 to display replay recommendation in a past program table that shows all channel programs recorded within last L weeks. In FIG. 11, elements similar to those shown in FIG. 8 are denoted by corresponding reference numbers, and no detailed description will be given thereof.

In the second embodiment, in step S4, it is determined whether there exists a program that was broadcasted at a certain time point within each of the last L weeks and was replayed. In step S8, it is determined whether or not a detected program is a sequential or associated one. If the program is determined to be a sequential or associated one, the processing proceeds to step S6 where the display region is overlaid with a replay-finish pointer position. In step S9, the processes in steps S8 and S6 are iterated on each program recorded at the above-mentioned time to thereby detect whether all L weeks are checked. If all L weeks are not checked, processing proceeds to step S10, where a program broadcasted at the same time point as the above one week before the currently checked week is detected and subjected to the processes in steps S8 and S6. As a result, the replay-finish pointer position in step S6 is sequentially overwritten a number of times by which an associated program was viewed at the above-mentioned time point within the last L weeks.

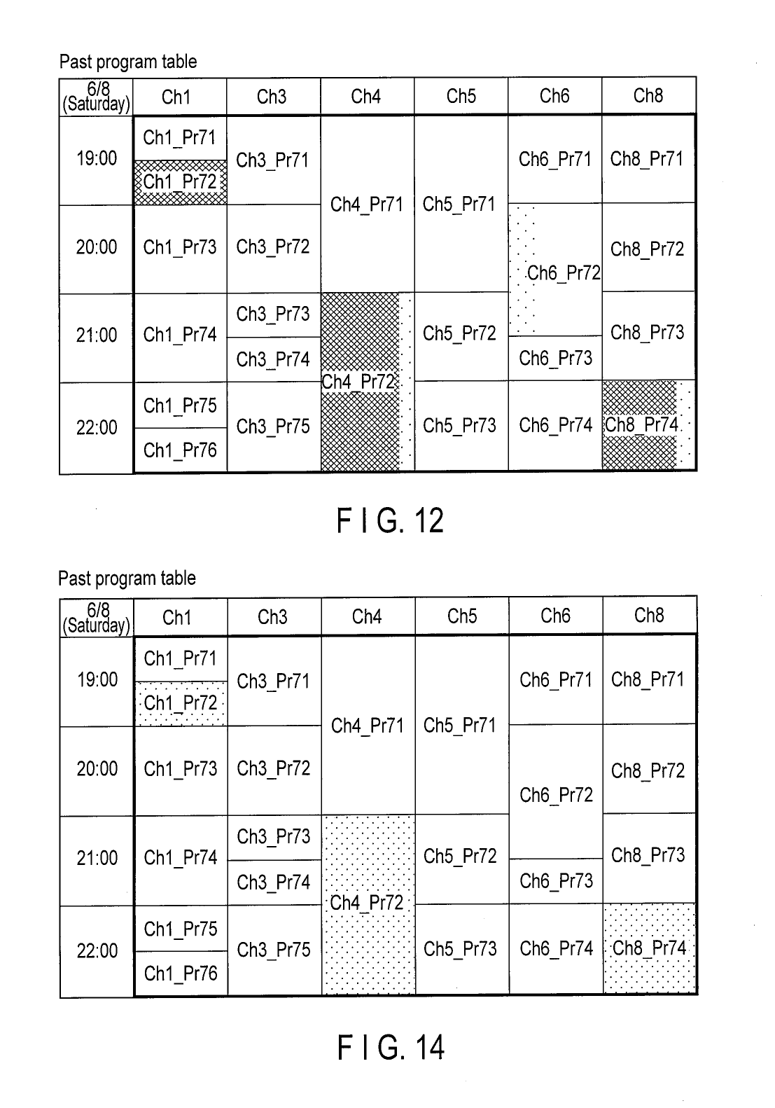

FIG. 12 shows an example of a replay reminding display for the past program table employed in the program recording apparatus capable of simultaneously recording all channel programs. FIG. 12 shows six channel programs (Ch1, Ch3, Ch4, Ch5, Ch6 and Ch8) broadcasted on June 8 (Saturday) from 19:00 to 22:00. In this example, although within the range displayed as the past program table, any programs are not yet replayed, the replay history is sequentially overwritten over the last two weeks, and is displayed as overlay display with a translucent color or translucent colors (in this case, the L weeks are two weeks). The “sequential overwriting of the replay history of the last L weeks to realize overlay display with a translucent color” is the feature of the second embodiment. This feature provides the advantage described below, which cannot be obtained by the conventional method.

As a specific method of realizing the second embodiment, information indicating each replay-finished program is overlaid with total replay-finish pointer position information (=replay-finish ratio information) (as described in the first embodiment) corresponding to the last L weeks, namely, each replay-finished program is overlaid with translucent colors corresponding to the last L weeks. In the example of FIG. 12, in information indicating some replayed programs, i.e., program frames (display regions) corresponding to the replayed programs, each of the replayed program is overlaid with horizontal bars each indicating by what % said each replayed program was replayed within the last two weeks. More specifically, in the example of FIG. 12, the replay-finish ratio of each program is as follows: On June 1 (Saturday), the program denoted by Ch1_Pr72 is 100%, the program denoted by Ch4_Pr72 is 100%, the program denoted by Ch6_Pr72 is approx. 20%, and the program denoted by Ch8_Pr74 is approx. 80%. Further, on May 25 (Saturday) one week before, the program denoted by Ch4_Pr72 is approx. 90%, the program denoted by Ch6_Pr72 is 0%, and the program denoted by Ch8_Pr74 is approx. 100%.

Thus, it can be understood at a glance that in the example of FIG. 12, the total relay-finish ratio of the program Ch1_Pr72 within the last two weeks is 100%+100%, that of the program Ch4_Pr72 is approx. 90%+100%, that of the program Ch6_Pr72 is 0%+approx. 20%, and that of the program Ch8_Pr74 is 100%+approx. 80%.

The second embodiment is characterized in that since the more important program (i.e., the program replayed more frequently) was overlaid with a plurality of translucent colors corresponding to the last L weeks, it is displayed in a more dense color and hence can be detected at a glance as a program to be viewed. It seems preferable to set the range of “L” to approx. 12 (weeks) at maximum, because in general, programs are expected to be changed after approx. three months (one series).

Based on the above-described replay history of the last two weeks, the user can correctly decide in such a way that the programs Ch1_Pr72, Ch4_Pr72 and Ch8_Pr74 should continue to be viewed because their replay ratios are substantially 80% or more, whereas the program Ch6_Pr72 does not have to be viewed any more because it was little replayed. Thus, definite order of priority can be imparted concerning programs to be viewed from now on, thereby realizing a replay reminding display on the past program table. Namely, a “week template” for selecting, for replay, a program or programs from the non-replayed programs in the past program table is formed.

Further, the instruction for “selecting, for replay, a program or programs” can be interpreted as an instruction to determine “which program(s) should be stored permanently,” if the user sets so. In other words, the instruction is used to remind the user “which program should be marked and processed quickly,” in view of the fact that in a typical recorder capable of simultaneously recording all channels, already recorded programs are automatically deleted from the oldest one when a recording buffer is full.

### Third Embodiment

A positive replay reminding method according to a third embodiment, different from the second embodiment, will now be described.

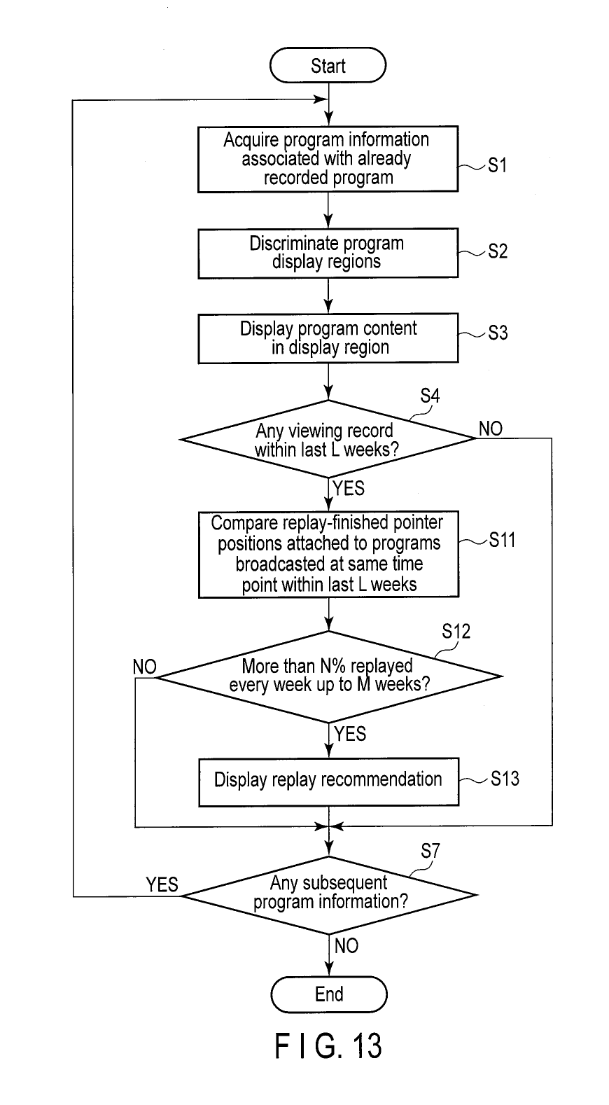

FIG. 13 is a flowchart of realizing a replay recommending display on a past program table according to the third embodiment, when all channel programs corresponding to the last L weeks are already stored in the program table processing unit 115. In FIG. 13, steps similar to those shown in FIGS. 8 and 11 are denoted by corresponding reference numbers, and no detailed description will be given thereof.

In the process shown in FIG. 13, if it is determined in step S4 that there exists a program that was broadcasted at a certain time point within each of the last L weeks and was replayed, the replay-finish pointer positions at the certain time points within the last L weeks are compared with each other (step S11), thereby determining whether N % or more of a sequential or associated program was replayed every week up to M weeks (step S12). If it is determined that N % or more of the program was replayed every week up to M weeks, this program is displayed as a replay recommended program (step S13).

FIG. 14 shows an example of the replay recommending display on the past program table employed in the third embodiment. Specifically, FIG. 14 shows six channel programs (Ch1, Ch3, Ch4, Ch5, Ch6 and Ch8) included in already recorded programs and broadcasted on June 8 (Saturday) from 19:00 to 22:00. In this example, although within the range displayed as the past program table, any programs are not yet replayed, the replay history is summed over the last L weeks and then subjected to screening using a certain condition, and the resultant history is presented as overlay display with a translucent color.

The “summing the replay history over the last L weeks, then subjecting the summing result to screening using the certain condition, and displaying the screening result as overlay display with a translucent color” is the feature of the third embodiment. Namely, as a specific method of realizing the third embodiment, information indicating each replay-finished program is overlaid with a translucent color that indicates the information obtained by screening, using the certain condition, the summing result of the replay history over the last L weeks.

In the example of FIG. 12 according to the second embodiment, replay history data is overwritten over the last L weeks, while in the example of FIG. 14 according to the third embodiment, the replay history data overwritten over the last L weeks is screened to thereby display, in a more simple manner, each program to be viewed. The condition for screening is, for example, that “N % or more of a sequential or associated program was replayed every week up to M weeks.” The values “M” and “N” can be arbitrarily selected by the user. By way of example, the user may set M and N to 2 and 80, respectively, namely, may set a condition that “80% or more of a sequential or associated program was replayed every week up to 2 weeks.” In FIG. 12, the programs Ch1_Pr72, Ch4_Pr72 and Ch8_Pr74 satisfy this condition. This is a preferable display when overlay display seems inappropriate, or when the user wishes definite replay recommendation for each program.

### Fourth Embodiment

Unlike the operations on the past program table (on the already recorded programs) in the first to third embodiments, a fourth embodiment is directed to a method of operating a future program table (this table shows programs, to be broadcasted in future, in a time series manner for each channel, these programs enabling the user to program recording or viewing), i.e., a method of further positively inducing programming of viewing and recording.

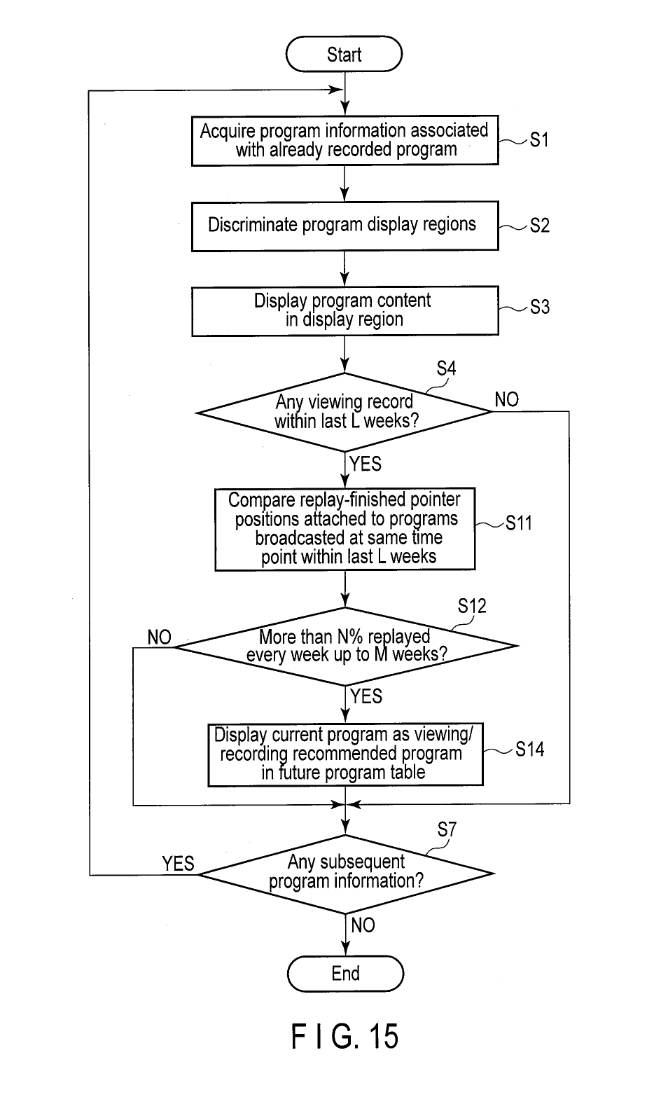

FIG. 15 is a flowchart of realizing a viewing/recording recommending display on a future program table according to the fourth embodiment, when all channel programs corresponding to the last L weeks are already recorded in the program table processing unit 115. In FIG. 15, steps similar to those shown in FIGS. 8, 11 and 13 are denoted by corresponding reference numbers, and no detailed description will be given thereof.

In the process shown in FIG. 15, in step S11, the replay-finish pointer positions of the programs broadcasted at the same time points within the last L weeks are compared with each other, thereby determining whether N % or more of a sequential or associated program was replayed every week up to M weeks (step S12). If it is determined that N % or more of the program was replayed every week up to M weeks, this program is displayed as a viewing/recording recommended program in the display region of a future program table (step S14).

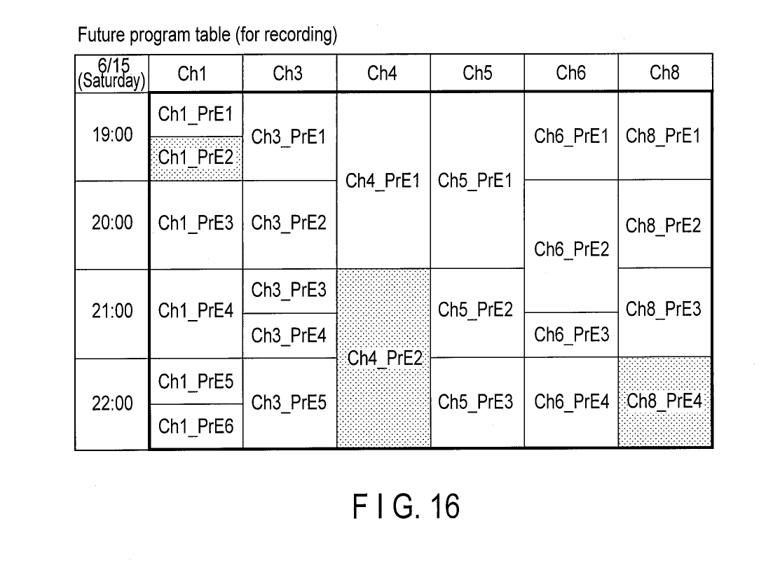

FIG. 16 shows an example of a viewing/recording programming recommending display on the future program table (for recording). Specifically, FIG. 16 shows six channel programs (Ch1, Ch3, Ch4, Ch5, Ch6 and Ch8) to be broadcasted on June 15 (Saturday) from 19:00 to 22:00, which are included in the programs to be broadcasted in future. In this example, although within the range displayed as the future program table, any programs are not yet replayed of course, the replay history is summed over the last L weeks and then subjected to screening using a certain condition, and the resultant history is presented in the display region of the future program table as overlay display with a translucent color, in the same way as the replay recommending display on the past program table shown in FIG. 14 according to the third embodiment.

The “summing the replay history over the last L weeks, then subjecting the summing result to screening using the certain condition, and displaying the screening result on the future program table as overlay display with a translucent color” is the feature of the fourth embodiment. Namely, as a specific method of realizing the fourth embodiment, information indicating each program in the future program table is overlaid with a translucent color that indicates the information, shown in FIG. 14, obtained by screening, using the certain condition, the summing result of the replay history over the last L weeks.

More specifically, the same checking as in the third embodiment shown in FIG. 14 is performed, thereby simply displaying programs to be programmed for recording or viewing. The condition for screening is, for example, that “N % or more of a sequential or associated program was replayed every week up to M weeks.” The values “M” and “N” can be arbitrarily selected by the user. By way of example, the user may set M and N to 2 and 80, respectively, namely, may set a condition that “80% or more of a sequential or associated program was replayed every week up to 2 weeks.” In the future program table shown in FIG. 16, the programs Ch1_PrE2, Ch4_PrE2 and Ch8_PrE4 satisfy this condition.

In the fourth embodiment, judging from the replay history over the last two weeks, it is considered that since the programs Ch1_PrE2, Ch4_PrE2 and Ch8_PrE4 were replayed every week up to two weeks at replay-finish ratios of 80% or more, they should be programmed for recording or viewing. In light of this, a recommending display is performed on the future program table (for, for example, recording). This recommending display forms a kind of “week template” for instructing selection, from a future program table, a program (programs) to be programmed for recording.

Further, the instruction for “selecting, for programming for recording, a program or programs” can be interpreted as an instruction to determine “which program(s) should be programmed for viewing,” if the user sets so. In other words, the instruction is used to remind the user “which program should be marked and programmed for recording or viewing,” among the programs to be broadcasted in future.

Although in the above-described embodiments, descriptions have been given of the case of using a so-called cloud service as the external service mechanism C1, the embodiments are also applicable to the case where the TV device itself incorporates a program storing device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A program managing system for recording, over a predetermined term, programs broadcasted through a plurality of channels, and providing a designated program in response to a user's request through a network, comprising:
a program table generator configured to generate a past program table showing program content in display regions of the respective recorded programs, based on program information on the recorded programs corresponding to the plurality of channels; and
a display controller configured to overlay a display region of an already replayed program in the past program table with a translucent color indicating a bar graph corresponding to a replay-finish ratio, based on a replay history included in the program information.

2. The program managing system of claim 1, wherein the display controller is also configured to display a replay-finish indicating mark in the display region of the already replayed program.

3. The program managing system of claim 1, wherein
the already replayed program is a continuous or associated program broadcasted in a past predetermined term; and
the display controller is configured to overlay the display region of the already replayed program with translucent colors indicating replay-finish ratios of the continuous or associated program.

4. The program managing system of claim 1, wherein
the already replayed program is a continuous or associated program broadcasted in a past predetermined term; and
the display controller is configured to display the display region of the already replayed program as a replay recommended program region when replay-finish ratios of the continuous or associated program continuously reached a predetermined value for a predetermined term.

5. The program managing system of claim 1, wherein
the program table generator is also configured to generate a future program table based on a broadcasting schedule of programs to be broadcasted through the plurality of channels; and
the display controller is also configured to display, as a recording or viewing recommended program region, a display region in the future program table corresponding to the already replayed program, when a replay-finish ratio of the already replayed program continuously reached a predetermined value for a predetermined term.

6. A program recording device for recording, over a predetermined term, programs broadcasted through a plurality of channels, and replaying the programs in response to a user's input operation, comprising:
a program table generator configured to generate a past program table showing program content in display regions of the respective recorded programs, based on program information on the recorded programs corresponding to the plurality of channels; and
a display controller configured to overlay a display region of an already replayed program in the past program table with a translucent color indicating a bar graph representing a replay-finish ratio, based on a replay history included in the program information.

7. The program recording device of claim 6, wherein the display controller is also configured to display a replay-finish indicating mark in the display region of the already replayed program.

8. The program recording device of claim 6, wherein
the already replayed program is a continuous or associated program broadcasted in a past predetermined term; and
the display controller is configured to overlay the display region of the already replayed program with translucent colors indicating replay-finish ratios of the continuous or associated program.

9. The program recording device of claim 6, wherein
the already replayed program is a continuous or associated program broadcasted in a past predetermined term; and
the display controller is configured to display the display region of the already replayed program as a replay recommended program region when replay-finish ratios of the continuous or associated program continuously reached a predetermined value for a predetermined term.

10. The program recording device of claim 6, wherein
the program table generator is also configured to generate a future program table based on a broadcasting schedule of programs to be broadcasted through the plurality of channels; and
the display controller is also configured to display, as a recording or viewing recommended program region, a display region in the future program table corresponding to the already replayed program, when a replay-finish ratio of the already replayed program continuously reached a predetermined value for a predetermined term.

11. A program managing method of recording, over a predetermined term, programs broadcasted through a plurality of channels, and providing a designated program in response to a user's request through a network, comprising:
generating a past program table showing program content in display regions of the respective recorded programs, based on program information on the recorded programs corresponding to the plurality of channels; and
overlaying a display region of an already replayed program in the past program table with a translucent color indicating a bar graph corresponding to a replay-finish ratio, based on a replay history included in the program information.

12. The program managing method of claim 11, further comprising displaying a replay-finish indicating mark in the display region of the already replayed program.

13. The program managing method of claim 11, wherein the already replayed program is a continuous or associated program broadcasted in a past predetermined term, and further comprising overlaying the display region of the already replayed program with translucent colors indicating replay-finish ratios of the continuous or associated program.

14. The program managing method of claim 11, wherein the already replayed program is a continuous or associated program broadcasted in a past predetermined term, and further comprising displaying the display region of the already replayed program as a replay recommended program region when replay-finish ratios of the continuous or associated program continuously reached a predetermined value for a predetermined term.

15. The program managing method of claim 11, further comprising:
generating a future program table based on a broadcasting schedule of programs to be broadcasted through the plurality of channels; and
displaying, as a recording or viewing recommended program region, a display region in the future program table corresponding to the already replayed program, when a replay-finish ratio of the already replayed program continuously reached a predetermined value for a predetermined term.
